(19) United States
(12) Patent Application Publication
(10) Pub. No.: US 2024/0343936 A1
(43) Pub. Date: Oct. 17, 2024

(54) WATERBORNE EPOXY RESIN COATING WITH GRAPHENE-COMPOSITE FOR VEHICLE SEAT TRACKS WITH SELF-LUBRIFICATION AND ANTICORROSION PROPERTIES

(71) Applicant: Ford Global Technologies, LLC, Dearborn, MI (US)

(72) Inventors: Rodrigo Denizarte de Oliveira Polkowski, Salvador (BR); Elisa Magno Nunes de Oliveira, Porto Alegre (BR); Ricardo Albuquerque, Salvador (BR); Luiz Hurtado, Lauro de Freitas (BR); Mariana Balieiro Sormani, Jaú (BR); Marcelo Tannure, Salvador (BR)

(73) Assignee: Ford Global Technologies, LLC, Dearborn, MI (US)

(21) Appl. No.: 18/300,008

(22) Filed: Apr. 13, 2023

(51) Int. Cl. C09D 163/00; C08K 3/04; C25D 13/12

(52) U.S. Cl. CPC C09D 163/00; C08K 3/042; C25D 13/12

(57) ABSTRACT

Metal components coated with a paint composition formed of an epoxy resin, a graphene and/or graphene-based species, and an additive of a siloxane and/or derivative of a siloxane are disclosed. Such painted metal components do not require a lubricant applied thereover.

### FIELD

The present disclosure relates to epoxy resin coatings including graphene composites for metal components.

### BACKGROUND

The statements in this section merely provide background information related to the present disclosure and may not constitute prior art.

In several applications having metal components, paint compositions are applied thereover for various reasons, such as to prevent rust, corrosion, to provide aesthetic appearances, and the like. In applications where the metal components move relative to one another in a manner that may generate friction, it is desirable to reduce such friction to prevent grinding, or detrimental effects to the surface of the metal component, such as grinding, chipping, or other defects of the paint compositions. The performance and durability of the paint compositions depend on various parameters that may be controlled or controllable, including but not limited to, the type of metallic component, any pretreatment of the substrate, as well as curing and coating thickness profiles desired of the paint compositions, adhesion between the paint composition and the metal component, and external environmental conditions.

A countervailing requirement in applications where the metal components move relative to one another is to allow for some play between the metal components while inhibiting rattling, degradation of mechanical performance (e.g., due to the paint composition cracking, peeling, or the like), squeaking, unwanted noise, or vibration during normal operation. In not-limiting examples, such metal components may include adjustable vehicle seat tracks, door latches, adjustable head restraint rods, among others, and accordingly it is desirable to inhibit rattling, squeaking, unwanted noise, or vibration during operation of the vehicle and to maintain mechanical performance.

Further, many conventional paint composition coating technologies produce undesirous volatile organic compounds as a byproduct. To address such issues, conventional technologies have included applying a lubricant over the paint compositions. Care should be taken in selecting among available conventional lubricants to not select those more likely to cause staining, discolorations, spills, leaks, or the like.

The present disclosure addresses these issues related to coating of metal components, and in particular for automotive/motor vehicle applications.

### SUMMARY

This section provides a general summary of the disclosure and is not a comprehensive disclosure of its full scope or all of its features.

According to one form of the present disclosure, a waterbone-based coating includes an epoxy resin; a graphene, a graphene-based species, or a mixture of graphene and a graphene-based species; and an additive being at least one of a siloxane, a derivative of a siloxane, a polypirrol, a derivative of a polypirrol, a polyaniline, a derivative of a polyaniline, an organosilane, and a derivative of an organosilane.

In variations of this form, which may be implemented individually or in any combination: the graphene, graphene-based species, or mixture of graphene and graphene-based species is at greater than 0.1 wt. % to less than or equal to about 5 wt. % of the coating; the graphene, graphene-based species, or mixture of graphene and graphene-based species is functionalized with at least one of an amine group, an amide group, a hydroxy group, and a carboxyl group; the additive is at least one of a polydimethylsiloxane and a polydimethylsiloxane derivative; the epoxy resin is at less than or equal to about 30 wt. % of a bio-based epoxy resin; and, the bio-based epoxy resin includes at least one of vegetable oil, soybean oil, cardanol oil, castor bean oil, linseed oil, and palm oil; and a part has the coating electrodeposited thereon.

According to a second form of the present disclosure, a waterborne-based coating includes an epoxy resin at greater than 0 wt. % to less than or equal to about 30 wt. % of a bio-based epoxy resin; a graphene, graphene-based species, or mixture of graphene and graphene-based species; and at least an additive.

In variations of this form, which may be implemented individually or in any combination: the graphene, graphene-based species, or mixture of graphene and graphene-based species is at greater than 0.1 wt. % to less than or equal to about 5 wt. % of the coating; the graphene, graphene-based species, or mixture of graphene and graphene-based species is functionalized at least one of an amine group, an amide group, a hydroxy group, and a carboxyl group; the epoxy resin includes an epoxy resin selected from the group comprising diphenyl propane derivatives, bisphenol A diglycidyl ether, bisphenol F epoxy resin, novolac epoxy resin, aliphatic epoxy resin, glycidylamine epoxy resin, and mixtures thereof; the additive is at least one of a polydimethylsiloxane and a polydimethylsiloxane derivative; and, the coating includes at least one of a curing agent and a crosslinking agent.

According to a third form of the present disclosure, a method of applying a waterborne-based coating over a metal component includes mixing an epoxy resin, a graphene, and an additive comprising at least one of a siloxane, a derivative of a siloxane, a polypirrol, a derivative of a polypirrol, a polyaniline, a derivative of a polyaniline, an organosilane, and a derivative of an organosilane thereof to form the waterbone-based coating; and electrodepositing the waterborne-based coating over the metal component.

In variations of this form, which may be implemented individually or in any combination: the additive includes at least one of a polydimethylsiloxane and a polydimethylsiloxane derivative; the graphene includes a graphene, graphene-based species, or mixture of graphene and graphene-based species; the graphene is at greater than 0.1 wt. % and less than or equal to about 5 wt. % of the coating; the epoxy resin includes (i) a first epoxy resin selected from the group of diphenyl propane derivatives, bisphenol A diglycidyl ether, bisphenol F epoxy resin, novolac epoxy resin, aliphatic epoxy resin, glycidylamine epoxy resin, and mixtures thereof; and (ii) a second epoxy resin comprised of a bio-based epoxy resin; the second epoxy resin is at greater than or equal to about 5 wt. % to less than or equal to about 30 wt. % of the epoxy resin; and the metal component is a vehicle seat track.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a vehicle seat with adjustable seat tracks coated with the composition of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

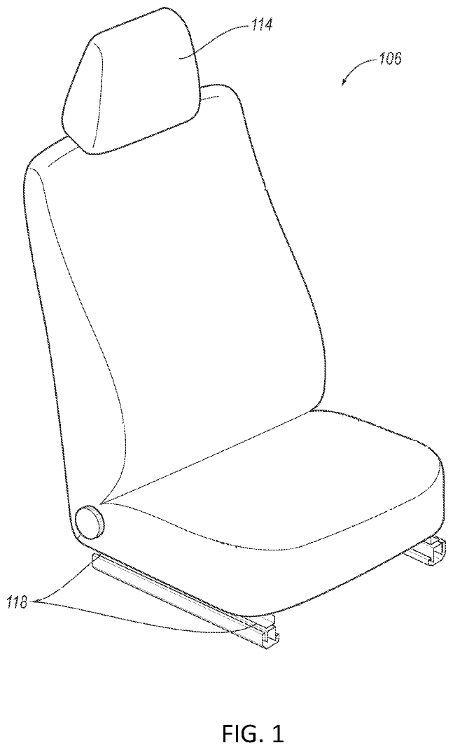

Referring to FIG. 1, according to a form, a metal component 118 is coated with the coatings disclosed herein. Appropriate metal components include aluminum, magnesium, alloys thereof, and other metals that may benefit from the coatings disclosed here. While metal component 118 is exemplarily displayed as vehicle seat tracks forming the base for an automobile vehicle seat 106 including a head rest 114, the scope of the disclosure includes other metal components where it would be desirous to have coated thereon the coating disclosed herein, such as door latches, adjustable head rest restraint rods, and the like.

The coating is prepared from a mixture of an epoxy resin, a graphene, and an additive. The coating offers superior reductions in friction coefficients of metal components, increase durability, and delay corrosion of the metal components. Accordingly, it is contemplated that lubricants, required by conventional approaches to metal components having paint compositions, are not required while still operating as well as conventional metal components having lubrication according to conventional technologies.

As used herein, “epoxy resin” includes diphenyl propane derivatives, bisphenol A diglycidyl ether, bisphenol F epoxy resin, novolac epoxy resin, aliphatic epoxy resin, glycidylamine epoxy resin, and mixtures thereof, among others.

Further, it is contemplated that as much as 30% by weight of the epoxy resin may be a bio-based epoxy resin. As used herein, bio-based epoxy resin includes vegetable oil, soybean oil, cardanol oil, castor bean oil, linseed oil, and palm oil, and mixtures thereof, among others. It is contemplated that under some forms, the epoxy resin includes greater than 0 wt. % to less than or equal to about 30 wt. % of the bio-based epoxy resin, including all sub-ranges.

As used herein, graphene includes graphene, graphene-based species, and mixtures of graphenes and graphene-based species. Graphene-based species as used herein is intended to include graphene oxides, reduced graphene oxides, and graphene nanoplatelets, among others. Further, it is contemplated that the graphenes disclosed hereunder are at greater than 0.1 wt. % to less than or equal to about 5 wt. % of the coating, including all sub-ranges.

The graphenes disclosed hereunder may be functionalized with at least one of an amine group, a hydroxy group, and a carboxyl group, among others.

The graphenes disclosed hereunder may be further modified with a filler or coupling agent based on at least one of a polypirrol, a derivative of a polypirrol, a polyaniline, a derivative of a polyaniline, an organosilane, and a derivative of an organosilane. In such forms, it is contemplated that such graphene may be modified with the filler or coupling agent at greater than or equal to about 5 wt. % to less than or equal to about 20 wt. % of the weight of the graphene, including all sub-ranges.

The addition of graphene in the paint composition provides better phase mixture and homogeneity between the polymeric resin of the epoxy resin and graphene structures among the film formed on the surface of the metal components. The graphene further serves as a barrier in the coating, thereby hindering corrosion of the metal components.

Further, the addition of graphene, being chemically inert, densely packed, and having an atomically smooth surface with having high strength and shear capability, provides better tribological characteristics and reduces the frequency and nature of bubbling of the epoxy resin and enhancing its compactness. And graphene's high thermal conductivity promotes dissipation of heat generated when metal components slide relative to one another.

As used herein, additives include a siloxane and a derivative of a siloxane. Where the additive is a siloxane, it is further contemplated the additive may be polydimethylsiloxane. Where the additive is a derivative of a siloxane, it is further contemplated the additive may be a polydimethylsiloxane derivative.

Where the additive is a polymethylsiloxane derivative, it is further contemplated the additive may be polysiloxane functionalized polymethylsiloxane derivatives, including, among others, monoglycidylether-terminated, diglycidyl ether-terminated, hexamethyl-terminated, and vinyl-terminated derivatives. The additives further enhance the tribological properties of the coated metal component and inhibit the requirement that conventionally coated metal components have for a lubricating grease applied thereover. Without wishing to be bound by theory, it is believed that the paint composition according to the present disclosure is self-lubricating thereby reducing or eliminating a separate lubricant.

The paint composition may further optionally include additional components. By way of not-limiting example, the paint composition may further include curing agents and/or cross-linking agents to improve desired qualities of the coated metal component.

The paint composition according to the present disclosure is waterborne-based. In other words, the paint composition process, as disclosed more fully below, reduced the reliance on petroleum content and is free of heavy metals; as such, the disclosed paint composition offers substantial environmental benefits over conventional paint compositions that rely on petroleum content and/or heavy metals.

As noted above, a mixture is formed of the epoxy resin, graphene, additive, and any other desired components (e.g., a curing agent) in water. A metal component may undergo initial pre-treatment steps (e.g., cleaning) and is then submerged in the mixture, and a voltage is applied to electrodeposit the paint composition over the metal component. The coated metal component may then be rinsed and cured as necessary.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A waterborne-based coating comprising:
an epoxy resin;
a graphene, a graphene-based species, or a mixture of graphene and a graphene-based species; and
an additive, the additive comprising at least one of a siloxane and a derivative of a siloxane.

2. The coating according to claim 1, wherein the graphene, graphene-based species, or mixture of graphene and graphene-based species is at greater than 0.1 wt. % to less than or equal to about 5 wt. % of the coating.

3. The coating according to claim 1, wherein the graphene, graphene-based species, or mixture of graphene and graphene-based species is functionalized with at least one of an amine group, an amide group, a hydroxy group, and a carboxyl group.

4. The coating according to claim 1, wherein the additive comprises at least one of a polydimethylsiloxane and a polydimethylsiloxane derivative.

5. The coating according to claim 1, wherein the epoxy resin comprises less than or equal to about 30 wt. % of a bio-based epoxy resin.

6. The coating according to claim 5, wherein the bio-based epoxy resin comprises at least one of vegetable oil, soybean oil, cardanol oil, castor bean oil, linseed oil, and palm oil.

7. A part having the coating of claim 1 electrodeposited thereon.

8. A waterborne-based coating comprising:
an epoxy resin comprising greater than 0 wt. % to less than or equal to about 30 wt. % of a bio-based epoxy resin;
a graphene, graphene-based species, or mixture of graphene and graphene-based species; and
at least one additive.

9. The coating according to claim 8, wherein the graphene, graphene-based species, or mixture of graphene and graphene-based species is at greater than 0.1 wt. % to less than or equal to about 5 wt. % of the coating.

10. The coating according to claim 8, wherein the graphene, graphene-based species, or mixture of graphene and graphene-based species is functionalized at least one of an amine group, an amide group, a hydroxy group, and a carboxyl group.

11. The coating according to claim 8, wherein the epoxy resin further comprises an epoxy resin selected from the group comprising diphenyl propane derivatives, bisphenol A diglycidyl ether, bisphenol F epoxy resin, novolac epoxy resin, aliphatic epoxy resin, glycidylamine epoxy resin, and mixtures thereof.

12. The coating according to claim 8, wherein the additive comprises at least one of a polydimethylsiloxane and a polydimethylsiloxane derivative.

13. The coating according to claim 8, wherein the coating further comprises at least one of a curing agent and a crosslinking agent.

14. A method of applying a waterborne-based coating over a metal component, the method comprising:
mixing an epoxy resin, a graphene, and an additive comprising at least one of a siloxane, a derivative of a siloxane, a polypirrol, a derivative of a polypirrol, a polyaniline, a derivative of a polyaniline, an organosilane, and a derivative of an organosilane thereof to form the waterbone-based coating; and
electrodepositing the waterborne-based coating over the metal component.

15. The method according to claim 14, wherein the additive comprises at least one of a polydimethylsiloxane and a polydimethylsiloxane derivative.

16. The method according to claim 14, wherein the graphene comprises a graphene, graphene-based species, or mixture of graphene and graphene-based species.

17. The method according to claim 16, wherein the graphene is at greater than 0.1 wt. % and less than or equal to about 5 wt. % of the coating.

18. The method according to claim 14, wherein the epoxy resin comprises:
a first epoxy resin selected from the group of diphenyl propane derivatives, bisphenol A diglycidyl ether, bisphenol F epoxy resin, novolac epoxy resin, aliphatic epoxy resin, glycidylamine epoxy resin, and mixtures thereof; and
a second epoxy resin comprised of a bio-based epoxy resin.

19. The method according to claim 18, wherein the second epoxy resin is at greater than or equal to about 5 wt. % to less than or equal to about 30 wt. % of the epoxy resin.

20. The method according to claim 14, wherein the metal component is a vehicle seat track.
